(19) United States
(12) Patent Application Publication
(10) Pub. No.: US 2017/0002108 A1
(43) Pub. Date: Jan. 5, 2017

(54) PROCESS FOR THE PREPARATION OF A SPHERICAL SUPPORT COMPRISING MgCl2 AND ALCOHOL

(71) Applicant: BASELL POLIOLEFINE ITALIA S.R.L., Milano (IT)

(72) Inventors: Giuseppina Maria ALGOZZINI, Ferrara (IT); Nicolo ARICH DE FINETTI, Ferrara (IT); Maria DI DIEGO, Ferrara (IT); Anna FAIT, Ferrara (IT); Luca RANZANI, Ferrara (IT)

(73) Assignee: BASELL POLIOLEFINE ITALIA S.R.L., MILANO (IL)

(21) Appl. No.: 15/106,701

(22) PCT Filed: Dec. 15, 2014
(86) PCT No.: PCT/EP2014/077681

§ 371 Date: Jun. 20, 2016

(30) Foreign Application Priority Data
Dec. 19, 2013 (EP) 1319833.5

(51) Int. Cl. C08F 4/02

(52) U.S. Cl. CPC C08F 4/02

(57) ABSTRACT

The present disclosure relates to a process for preparing a MgCl₂-alcohol adduct which comprises (a) forming a mixture of an MgCl₂-alcohol adduct in molten form and a liquid which is immiscible with the adduct, (b) subjecting the mixture to a shear stress to obtain an emulsion, and (c) rapidly cooling the emulsion to solidify the disperse phase and collecting the solid adduct particles, the process being characterized by the fact that step (b) is carried out in a device comprising a first outer and second inner cylindrical members that define an annulus between them, wherein at least one of the cylindrical members rotate with respect to the other.

### FIELD OF THE INVENTION

The present disclosure relates to a process for preparing a support, in the form of spherical particles with narrow particle size distribution, which can be used in the preparation of olefin polymerization supported catalysts. In some embodiments, the present disclosure relates to a process for preparing the support, which involves forming an emulsion of a liquid molten adduct of magnesium dihalide and an alcohol with an immiscible liquid by feeding the liquids to a Couette type device generating a constant shear stress throughout the flow domain. This process produces support particles capable of generating catalysts that give polymers in higher yields and/or with improved morphology.

### BACKGROUND OF THE INVENTION

The availability of catalysts able to produce polymers with optimal morphological properties is a fundamental requirement in any olefin polymerization technology. A polymer having a spherical regular form allows for increased bulk density and efficient transport within the various sections of the plant. In addition, a narrow polymer particle size distribution allows for easier handling of the polymer transfer, minimizing the problems due to the presence of excessively big or small particles. The replica phenomena, by which controlled polymerization conditions attributable to the morphological properties of a catalyst are transferred on a magnified scale to the polymer, necessitates the requirement for regular morphology and narrow particle size distribution be transferred to the catalyst.

In the field of olefin polymerization, Ziegler-Natta catalyst components are customarily used in the industrial polymerization process. They usually comprise a titanium compound supported on magnesium chloride in active form and, when stereospecificity is required, they may also comprise an electron-donating compound. In the polymerization process they are often used together with an organo-aluminum compound as a co-catalyst activator and, when needed, also in combination with an additional stereomodulating agent (an external electron donor). In order to impart beneficial morphological properties, the supports comprising magnesium chloride (MgCl₂) can be prepared by many different processes. Some of these processes include the formation of a molten adduct of magnesium chloride and a Lewis base, usually an alcohol, followed by spraying in an atmosphere at low temperature (“spray-cooling”) for solidifying the adduct.

Another general method widely used in the preparation of spherical supports containing MgCl₂ consists of melting the adduct, with stirring, in a liquid medium in which the adduct is immiscible, and transferring the mixture into a cooling bath containing a liquid at low temperature, in which the adduct is insoluble, which is capable of bringing about rapid solidification of the adduct in the form of spherical particles.

While the spherical form is due to the formation of droplets of the dispersed phase of the emulsion into the continuous phase, the particle size is a function of the energy provided to the emulsion system and, maintaining constant all of the other features (e.g., shape of the tank and stirrer, type of oil, etc.), the particle size is inversely related to the intensity of stirring. Thus, in order to produce a precursor composition with reduced particle size, a higher amount of energy, such as a higher stirring rate, is usually provided. Under these conditions it is difficult to obtain a narrow particle size distribution, because with the reduction of size the coalescence phenomena will increase.

An example of this process is described in WIPO Pat. App. Pub. No. WO2005/039745, specifically a method for preparing the magnesium chloride/ethanol adduct comprising subjecting at least two immiscible liquids to a sequence of at least two mixing stages, carried out in at least two successive stator-rotor devices, wherein a peripheral outlet from a first stator rotor device is connected to an axial inlet in the successive stator rotor device by means of a duct, in which the Reynold number (Re_{T}) inside said duct is higher than 5000, and the peripheral velocity of each rotor of said stator-rotor devices ranges from 5 to 60 m/s.

Due to the rotor/stator configuration and rotation speed, the shear stress imparted to the system is largely not constant and results in, with a single rotor/stator stage, a broad particle size distribution as evidenced by the results obtained in Comparative Example 1. According to WIPO Pat. App. Pub. No. WO2005/039745, it is necessary to add additional stages (at least one but preferably two) in order to generate a more uniform system and to narrow the particle size distribution. However, this process is complicated and it would be advisable to find an easier way to produce catalyst precursors with narrow particle size distributions over a broad range of average particle size.

Devices capable of generating emulsions by applying a more constant shear stress are known in the art. For instance, U.S. Pat. No. 7,581,436 describes a method for operating a Couette device to prepare and study emulsions. A Couette device is an apparatus comprising two concentric cylinders rotating at different angular velocities. A peculiar characteristic of this model is that shear stress is constant throughout the flow domain. However, according to Grace (Chemical Engineering Communications 14, 225-277), such systems are effective only when the viscosity of the two phases of the emulsion are similar. In cases of very low or high viscosity ratios it becomes several hundred times more difficult to break a drop by uniform rotational shear as described in U.S. Pat. No. 7,581,436, wherein the wide applicability limits the working examples to emulsions composed by crude oil and water, which have similar viscosities.

### SUMMARY OF THE INVENTION

In view of the above, it was surprising to discover that a Couette device could be very effective in the preparation of emulsions of magnesium dichloride/ethanol adduct in an immiscible liquid hydrocarbon because of their very different viscosities and very high viscosity ratio.

The present disclosure relates to a process for preparing a MgCl₂-alcohol adduct comprising (a) forming a mixture of an MgCl₂-alcohol adduct in molten form and a liquid which is immiscible with the said adduct, (b) subjecting the mixture to a shear stress in order to obtain an emulsion, and (c) rapidly cooling the emulsion to solidify the disperse phase and collecting the solid adduct particles, said process being characterized by the fact that step (b) is carried out in a device generating a shear stress constant through the flow domain and comprising a first outer and second inner cylindrical members that define an annulus between them, wherein at least one of said cylindrical members rotate with respect to the other.

### DETAILED DESCRIPTION OF THE INVENTION

According to one aspect of the disclosure, the device comprises a Couette type device with first (outer) and second (inner) cylindrical members that define an annulus between them, wherein at least one of the cylindrical members rotates with respect to the other. Examples of Couette devices are described in U.S. Pat. Nos. 6,959,588 and 5,959,194. In a further embodiment, the first outer cylinder is stationary while the second internal cylinder is the rotational or capable of rotating.

Generally, the Reynolds number (Re_{T}) and the shear coefficient (SH) related to the movement of the emulsion inside the Couette device are defined by the following formulas:

Re_{T}=δu*h/μ; and (1)

SH=u/h (2)

where u is the peripheral speed of the rotor at the rotor surface (radius rᵢ), h is the anular gap width between the inner cylinder (radius ri) and the outer cylinder (radius rₒ), δ and μ are the density and the viscosity of the emulsion respectively. This latter is calculated on the basis of a version of the Taylor model defined in equation 13 of Rheology of Emulsions—Derkach, S. R., Adv. Colloid. Interface Sci. 2009 Oct. 30; 151(1-2):1-23 (doi: 10.1016/j.cis.2009.07.001. E-published Jul. 10, 2009), relating to the study of rheological behavior of adduct concentrated emulsions and their concentration dependence on viscosity.

In general, with the increase of gap size, Re_{T} increases while the SH rate decreases. Although certain parameters may vary depending on the scale of the device, in one embodiment the radial tolerance between the surfaces of the cylinders, intended as the radial difference between the circumference of each cylinder, ranges from 0.1 up to 20 mm, such as from 0.2 to 5 mm, while the rotor diameter ranges from 20 mm up to 600 mm, including from 80 to 200 mm.

Under this setup, the rotary cylinder may be rotated at a velocity in a range from 200 to 8000 rpm, such as from 600 to 5000 rpm.

Generally, the Reynolds number may range from 300 to 400000, including from 500 to 10000.

The liquid medium used in stage (a) can be any liquid medium which is inert with respect to, and substantially immiscible with, the MgCl₂ alcohol adduct. In some embodiments, the liquid medium is an organic liquid medium selected from the group consisting of aliphatic and aromatic hydrocarbons, silicone oils, liquid polymers or mixtures of the compounds. In some embodiments, the liquid media are paraffin oils and silicone oils having a viscosity of greater than 15 centiPoise (cP) at room temperature, such as between 22 and 270 cP.

The MgCl₂-alcohol adduct is prepared by contacting MgCl₂ and alcohol, heating the system at the melting temperature of MgCl₂-alcohol adduct or above, and maintaining said conditions so as to obtain a completely melted adduct. In particular embodiments, the adduct is kept at a temperature equal to or higher than its melting temperature, under stirring conditions, for a time period equal to or greater than 2 hours, such as 2 to 50 hours and from 5 to 40 hours.

In some embodiments, the alcohol forming the adduct with the MgCl₂ is selected from the alcohols of the general formula ROH, in which R is an alkyl group containing from 1 to 10 carbon atoms. In certain embodiments, R is a C₁-C₄ alkyl such as ethyl. The use of MgCl₂ as a magnesium dihalide is contemplated in certain embodiments.

In further embodiments, the adducts may be represented by the general formula MgCl₂.mROH.nH₂O, in which m ranges from 0.1 to 6, n ranges from 0 to 0.7 and R has the meaning given above. Among the adducts for use in the present disclosure are those in which m ranges from 2 to 4, n ranges from 0 to 0.4 and R is ethyl.

In some embodiments, the viscosity of the adduct ranges from 20 to 200 cP at 125° C., such as from 50 to 100 cP at 125° C.

In additional embodiments, the relative feeding weight ratio of liquid immiscible medium to of molten adduct ranges from 3.5 to 8.

A person skilled in the art would appreciate that the formation of the emulsion, its stability and characteristics is the result of the combination of several parameters. For instance, it is possible to vary both the specific parameters of the emulsion (density, viscosity and also the type of continuous phase) and the operating parameters such as the type and dimensions of Couette device, the velocity of rotating cylinder and the temperature of the system. The selection and manipulation of these parameters allows those skilled in the art to work under the desired flow conditions that can generate solid adduct particles with different average sizes and/or particle size distributions.

As mentioned above, the emulsion is then transferred into the cooling bath. The transfer may be carried out under pressure by using a pipe connected at one end to the cooling bath. The diameter of the pipe is such that the Reynolds number in the pipe (Re_{T}) is ranging from 500 up to 20000.

The pipe length used to connect step a) and b) may be varied within a wide range, and may depend on the operating limits caused by the substantial pressure drops and/or by the compactness of the plant. It is also possible to use more than one transfer pipe having the same or different transfer pipe diameters.

For the purpose of the present disclosure, the terms “regular” or “spherical morphology” refer to particles having a ratio between the maximum diameter and minimum diameter of less than 1.5, such as less than 1.3.

As mentioned previously, the emulsion may be solidified in cooling step (b). The cooling step may be carried out by immersing one of the ends of the transfer pipe containing the emulsion in the cooling bath, where the cooling liquid moves inside a tubular zone. According to the present disclosure, the term “tubular zone” refers to a zone having the form of a tube, such as pipes or tubular reactors. Upon contacting the low-temperature liquid, the emulsion containing the droplets of the molten adduct is cooled, and the droplets are solidified into solid particles, which can then be collected by means of centrifugation or filtration. The cooling liquid may be any liquid which is inert with respect to the adduct and in which the adduct is substantially insoluble. For example, the liquid can be selected from the group consisting of aliphatic and aromatic hydrocarbons. In some embodiments, the compounds are aliphatic hydrocarbons containing from 4 to 12 carbon atoms, including hexane and heptane. In certain embodiments, a cooling liquid temperature of between −20° C. and 20° C. gives satisfactory results in terms of the rapid solidification of the resulting droplets. In the case of an adduct MgCl₂.nEtOH, in which n is between 2 and 4, the cooling liquid temperature may be between −10° C. and 20° C., such as between −5° C. and 15° C.

As described herein, the process of the present disclosure generates support particles with particle size distribution (SPAN) less than 1.4, including less than 1.2 and from 0.7 to 1.0. The particle size distribution (SPAN) is calculated with the formula

$$\frac{P 90 - P 10}{P 50} ,$$

wherein P90 is the value of the diameter such that 90% of the total volume of particles, have a diameter lower than that value; for instance, P10 is the value of the diameter such that 10% of the total volume of particles have a diameter lower than that value and P50 is the value of the diameter such that 50% of the total volume of particles have a diameter lower than that value.

The supports prepared by the process of the present disclosure are suitable for preparing catalytic components for the polymerization of olefins. The catalyst components are obtainable by reacting a transition metal compound of formula MPₓ, in which P is a ligand that is coordinated to the metal and x is the valence of the metal M, which is an atom selected from Groups 3 to 11 or the lanthanide or actinide groups of the Periodic Table of the Elements (new IUPAC version), with the catalytic supports disclosed herein. In some embodiments, transition metal compounds are Ti and V halides, alcoholates or haloalcoholates.

In one embodiment, the adduct can be directly reacted with the Ti compound or can be subjected to thermally controlled dealcoholation (at a temperature in a range of 80-130° C.), so as to obtain an adduct in which the number of moles of alcohol is generally lower than 3, such as a value between 0.1 and 2.5. The reaction with the Ti compound, preferably TiCl₄, can be carried out by suspending the adduct (dealcoholated or as such) in cold TiCl₄ (generally 0° C.); the mixture is heated up to 80-130° C. and kept at this temperature for 0.5-2 hours. The treatment with TiCl₄ can be carried out one or more times. The maleate can be added during the treatment with TiCl₄. The treatment with the electron donor compound can be repeated one or more times.

The preparation of catalyst components in spherical form is described for example in European Patent Applications EP-A-395083, EP-A-553805, EP-A-553806, EPA-601525 and WIPO Pat. App. WO098/44009.

The solid catalyst components obtained according to the above method show a surface area (by B.E.T. method) generally between 20 and 500 m²/g, including between 50 and 400 m²/g, and a total porosity (by B.E.T. method) higher than 0.2 cm³/g, such as between 0.2 and 0.6 cm³/g. The porosity (Hg method) due to pores with radius up to 10.000 Å generally ranges from 0.3 to 1.5 cm³/g, including from 0.45 to 1 cm³/g.

The catalyst components of the present disclosure form catalysts for the polymerization of alpha-olefins CH₂═CHR, wherein R is hydrogen or a hydrocarbon radical having 1-12 carbon atoms, by reaction with Al-alkyl compounds. The alkyl-Al compound can be of the general formula AlR_{3-z}X_{z} above, in which R is a C₁-C₁₅ hydrocarbon alkyl radical, X is a halogen such as chlorine and z is a number 0≦z<3. The Al-alkyl compound may be chosen among the trialkyl aluminum compounds such as trimethylaluminum, triethylaluminum, triisobutylaluminum, tri-n-butylaluminum, tri-n-hexylaluminum and tri-n-octylaluminum. It is also possible to use alkylaluminum halides, alkylaluminum hydrides or alkylaluminum sesquichlorides such as AlEt₂Cl and Al₂Et₃Cl₃, optionally in mixtures comprising trialkyl aluminum compounds. In some embodiments, the Al/Ti ratio is higher than 1, for instance between 50 and 2000.

In additional embodiments, it is possible to use an electron donor compound (external donor) which can be the same or different from the compound used as the internal donor. For instance, the internal donor may be an ester of a polycarboxylic acid, such as a phthalate, and the external donor may be selected from the silane compounds containing at least a Si—OR link, having the formula Rₐ¹R_{b}²Si(OR³)_{c}, where a and b are integer from 0 to 2, c is an integer from 1 to 3 and the sum (a+b+c) is 4; R¹, R², and R³, are alkyl, cycloalkyl or aryl radicals with 1-18 carbon atoms. In some embodiments, silicon compounds in which a is 1, b is 1, c is 2, at least one of R¹ and R² is selected from branched alkyl, cycloalkyl or aryl groups with 3-10 carbon atoms and R³ is a C₁-C₁₀ alkyl group, such as a methyl group, may be used. Examples of silicon compounds are methylcyclohexyldimethoxysilane, diphenyldimethoxysilane, methyl-t-butyldimethoxysilane, dicyclopentyldimethoxysilane and diisopropyldimethoxysilane. Moreover, silicon compounds in which a is 0, c is 3, R² is a branched alkyl or cycloalkyl group and R³ is methyl may be used. Examples of silicon compounds for use in the present technology are cyclohexyltrimethoxysilane, t-butyltrimethoxysilane and thexyltrimethoxysilane.

Also, cyclic ethers such as tetrahydrofuran and 1,3-diethers having the above described formula can be used as an external donor.

The components of the present disclosure and catalysts obtained therefrom may be used in processes for the (co)polymerization of olefins of the general formula CH₂═CHR, in which R is hydrogen or a hydrocarbon radical having 1-12 carbon atoms.

The catalysts of the present disclosure can be used in any of the olefin polymerization processes known in the art. They can be used, for example, in slurry polymerization processes using an inert hydrocarbon as a diluent or a solvent or bulk polymerization using the liquid monomer (for example, propylene) as a reaction medium. They can also be used in polymerization processes carried out in gas-phase operating in one or more fluidized or mechanically agitated bed reactors.

In some embodiments, the polymerization is generally carried out at temperature of from 20 to 120° C., such as from 40 to 80° C. When the polymerization is carried out in gas-phase, the operating pressure is generally between 0.1 and 10 MPa, including between 1 and 5 MPa. In bulk polymerization processes, the operating pressure is generally between 1 and 6 MPa, such as between 1.5 and 4 MPa.

The catalysts of the present disclosure are very useful for preparing a broad range of polyolefin products. Specific examples of the olefinic polymers which can be prepared are: high density ethylene polymers (HDPE, having a density higher than 0.940 g/cc), comprising ethylene homopolymers and copolymers of ethylene with alpha-olefins having 3-12 carbon atoms; linear low density polyethylenes (LLDPE, having a density lower than 0.940 g/cc) and very low density and ultra-low density polyethylenes (VLDPE and ULDPE, having a density lower than 0.920 g/cc, to 0.880 g/cc) consisting of copolymers of ethylene with one or more alpha-olefins having from 3 to 12 carbon atoms, having a molar content of units derived from the ethylene higher than 80%; isotactic polypropylenes and crystalline copolymers of propylene and ethylene and/or other alpha-olefins having a content of units derived from propylene higher than 85% by weight; copolymers of propylene and 1-butene having a content of units derived from 1-butene comprised between 1 and 40% by weight; heterophasic copolymers comprising a crystalline polypropylene matrix and an amorphous phase comprising copolymers of propylene with ethylene and or other alpha-olefins.

The catalyst components obtained from the adducts generate polymer particles of smaller diameter during polymerization which makes slurry processes easier to be controlled. The following examples are given in order to further illustrate the disclosure without limiting it.

The following examples are given to further illustrate without limiting in any way the present disclosure itself.

General Procedure for the Preparation of the Solid Catalyst Component

Into a 1 L steel reactor provided with a stirrer, 800 cm³ of TiCl₄ at 0° C. were introduced at room temperature and, during stirring, 16 g of the adduct were introduced together with an amount of diisobutylphthalate (DIBP) used as an internal donor so as to give a donor/Mg molar ratio of 10.

The whole was heated to 100° C. over 90 minutes and these conditions were maintained over 120 minutes. The stirring was stopped and after 30 minutes the liquid phase was separated from the settled solid, maintaining the temperature at 100° C. Two further treatments of the solid were carried out adding 750 cm³ of TiCl₄ and the mixture was heated up to 120° C. over a 10 min period, and these conditions were maintained for 60 min under stirring conditions (500 rpm). The stirring was then discontinued and after 30 minutes the liquid phase was separated from the settled solid maintaining the temperature at 120° C. Thereafter, three (3) washings with 500 cm³ of anhydrous hexane at 60 ° C., and three (3) washings with 500 cm³ of anhydrous hexane at room temperature were carried out. The solid catalyst component obtained was then dried under vacuum in a nitrogen environment at a temperature ranging from 40-45° C.

General Procedure for the Propylene Polymerization Test

A 4 litre steel autoclave equipped with a stirrer, pressure gauge, thermometer, catalyst feeding system, monomer feeding lines and thermostatting jacket, was used.

The reactor was charged with 0.01 g of solid catalyst component 0.76 g of TEAL, 0.076 g of dicyclopentyldimetoxy silane, 3.2 L of propylene, and 1.5 L of hydrogen. The system was heated to 70° C. over 10 min under stirring, and maintained at these conditions for 120 min. At the end of the polymerization, the polymer was recovered by removing any unreacted monomers and was dried under vacuum.

Average Particle Size and Particle Size Distribution of the Adduct and Polymers

Determined by a method based on the principle of the optical diffraction of monochromatic laser light with the “Malvern Instr. 2600” apparatus. The average size is given as P50.

### EXAMPLES

### Comparative Example 1 and Examples 2-3

A molten adduct of formula MgCl₂-2.7 EtOH and a white mineral oil OB55 marketed by ROL OIL are introduced into a Couvette device (Examples 2, 3)or a stirred tank (Comparative Example 1). After the emulsifying stage the emulsion is transferred, via transfer pipe to a cooling bath containing cold hexane, from which solid adduct particles are collected.

The characteristics of the shear generating devices are reported below:

| | Stirred Tank | Couette | Couette |
|---|---|---|---|
| | Comp. Ex. 1 | Ex. 2 | Ex. 3 |
| Impeller Diameter, mm | 67 | — | — |
| Rotor Diameter, mm | — | 96.2 | 96.2 |
| Radial tolerance, mm | — | 0.6 | 2 |

The table below reports the working conditions used to generate the solid adduct particles. The examples demonstrate that solid adduct particles with a narrower particle size distribution (SPAN) may be produced in accordance with the present disclosure.

| | | Example | | |
|---|---|---|---|---|
| | | Stirred Tank | Couette | Couette |
| | | Comp. Ex. 1 | Ex. 2 | Ex. 3 |
| Rpm | | 1100 | 1150 | 1400 |
| Re_{T} in transf. tube | — | 1100 | 990 | 920 |
| Continuous/dispersed | wt/wt | 7 | 6 | 6 |
| phases | | | | |
| P5 | micron | 16.2 | 30.2 | 28.59 |
| P50 | micron | 52.5 | 53.4 | 54.34 |
| P95 | micron | 111.6 | 92.8 | 100.24 |
| P99 | micron | 133.6 | 108.6 | 117.93 |
| Span | — | 1.41 | 0.92 | 1.04 |

### Example 4 and Comparative Example 2

In preparing the adduct of Example 4 the same Couette device used in Example 2 was used while the same apparatus used in Comparative Example 1 was used in Comparative Example 2. However, the working conditions were modified to produce an adduct having a smaller P50 size. The process disclosed herein was found to be capable for generating a much narrower particle size distribution with the same P50.

| Example | | Comp. Ex. 2 | Example 4 |
|---|---|---|---|
| Rpm | | 1550 | 1400 |
| Re_{T} in transf. tube | — | 1000 | 990 |
| Continuos/dispersed | wt/wt | 6 | 6 |
| phases | | | |
| P5 | micron | 17.9 | 20.8 |
| P50 | micron | 43.7 | 43.2 |
| P95 | micron | 96.3 | 86.1 |
| P99 | micron | 116.3 | 105.2 |
| Span | — | 1.4 | 1.19 |

### Example 5

A molten adduct of the stoichiometric formula MgCl₂-3.3EtOH and a white mineral oil OB55, marketed by ROL OIL, are introduced into the same Couette device as that of Example 2. The mixture, at a temperature of 125° C., is processed under the conditions reported below and then collected after the cooling stage, where solid particles with a very narrow particle size distribution were observed.

| | | Example 5 |
|---|---|---|
| Emulsion Device type | | Couette of Ex. 2 |
| Rpm | | 900 |
| Re_{T} in ED | — | 300 |
| Shear rate in ED | s\hat{ }−1 | 7600 |
| Re_{T} in transf. tube | — | 780 |
| Continuos/dispersed | wt/wt | 7.2 |
| phases | | |
| P1 | micron | 24.1 |
| P5 | micron | 28.6 |
| P50 | micron | 46.5 |
| P95 | micron | 74.5 |
| P99 | micron | 86.8 |
| Span | — | 0.78 |

### Polymerization Examples

The adducts generated in Comparative Example 1 and Example 3 were converted into catalyst components according to the general previously described. The resulting catalysts components were tested according to the general polymerization procedure and produced the results given below. A narrower particle size distribution of the support was obtained with the process of the present disclosure, as is reflected in the resulting polymer particles.

| Polymer from support of Example | | Comp. 1 | Ex. 3 |
|---|---|---|---|
| Polymer APS | micron | 2255 | 1872 |
| >4000 | | 5.2 | 0.5 |
| 3350 | | 6.6 | 2.7 |
| 2800 | | 11.0 | 7.3 |
| 2000 | | 40.9 | 34.3 |
| 1400 | | 21.1 | 27.1 |
| 1000 | | 4.9 | 14.1 |
| 710 | | 1.9 | 7.6 |
| 500 | | 2.8 | 3.4 |
| <500 | | 5.6 | 3.0 |
| Breaks | | 4.6 | 3.3 |

What is claimed is:

1. A process for preparing a MgCl₂-alcohol adduct comprising (a) forming a mixture of an MgCl₂-alcohol adduct in molten form and a liquid which is immiscible with the adduct, (b) subjecting the mixture to a shear stress in order to obtain an emulsion, and (c) rapidly cooling the emulsion to solidify the dispersed phase and collecting the solid adduct particles, wherein step (b) is carried out in a device generating a shear stress constant through the flow domain and comprising a first outer and second inner cylindrical member that define an annulus between them, wherein at least one of the cylindrical members rotate with respect to the other.

2. The process of claim 1, wherein at least one of the cylindrical members that rotate with respect to the other is a Couette type device.

3. The process of claim 1, wherein the first outer cylinder is stationery and the second internal cylinder is rotary.

4. The process of claim 1, wherein the radial tolerance between the surfaces of the cylinders, defined as the radial difference between the circumference of each cylinder ranges from 0.1 up to 20 mm, and the rotor diameter ranges from 20 mm up to 600 mm.

5. The process of claim 1, wherein the rotary cylinder is rotated at a velocity in the range from 200 to 8000 rpm.

6. The process of claim 1, wherein the liquid immiscible with the adduct is selected from the group consisting of aliphatic hydrocarbons, aromatic hydrocarbons, silicon based oils and mixtures thereof.

7. The process of claim 6, wherein the liquid has a viscosity ranging from 22 and 270 cPoise at room temperature.

8. The process of claim 1, wherein the adduct has the general formula MgCl₂.mROH.nH₂O in which m ranges from 0.1 to 6, n ranges from 0 to 0.7 and R is an alkyl group containing from 1 to 10 carbon atoms.

9. The process of claim 8, wherein R is an ethyl group.

10. The process of claim 1, wherein viscosity of the adduct ranges from 20 to 200 cP at 125° C.

11. The process of claim 1, wherein the relative feeding weight ratio of liquid immiscible medium to molten adduct ranges from 3.5 to 8.
